(19) United States
(12) Patent Application Publication
(10) Pub. No.: US 2020/0292972 A1
(43) Pub. Date: Sep. 17, 2020

(54) HEATING DEVICE, FIXING DEVICE, AND IMAGE FORMING APPARATUS

(71) Applicants: Daisuke INOUE, Tokyo (JP); Tomoya Adachi, Kanagawa (JP); Yuusuke Furuichi, Kanagawa (JP); Yukimichi Someya, Saitama (JP)

(72) Inventors: Daisuke INOUE, Tokyo (JP); Tomoya Adachi, Kanagawa (JP); Yuusuke Furuichi, Kanagawa (JP); Yukimichi Someya, Saitama (JP)

(21) Appl. No.: 16/750,046

(22) Filed: Jan. 23, 2020

(30) Foreign Application Priority Data
Mar. 13, 2019 (JP) 2019-045823

(51) Int. Cl. G03G 15/20

(52) U.S. Cl. CPC G03G 15/2053

(57) ABSTRACT

A heating device includes an endless rotator that rotates in a rotation direction. A heater contacts the endless rotator. An elastic body is disposed opposite an inner circumferential surface of the endless rotator and disposed downstream from the heater in the rotation direction of the endless rotator. A holder holds the heater and the elastic body. A pressure rotator is disposed opposite the heater and the elastic body via the endless rotator to form a nip between the endless rotator and the pressure rotator. A slide sheet covers a surface of the elastic body. The slide sheet includes an upstream end in the rotation direction of the endless rotator. The upstream end is sandwiched between the heater and the elastic body and between the elastic body and the holder. The upstream end is secured to the holder.

### CROSS-REFERENCE TO RELATED APPLICATION

This patent application is based on and claims priority pursuant to 35 U.S.C. § 119(a) to Japanese Patent Application No. 2019-045823, filed on Mar. 13, 2019, in the Japan Patent Office, the entire disclosure of which is hereby incorporated by reference herein.

### BACKGROUND

### Technical Field

Exemplary aspects of the present disclosure relate to a heating device, a fixing device, and an image forming apparatus, and more particularly, to a heating device incorporating a resistive heat generator, a fixing device incorporating the heating device, and an image forming apparatus incorporating the fixing device.

### Discussion of the Background Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography.

Such image forming apparatuses employ fixing devices of various types to fix the image on the recording medium.

For example, a fixing device includes a fixing belt that is thin and has a decreased thermal capacity. The fixing belt is looped over a plurality of rollers. A laminated heater constructed of a base and a resistive heat generator heats an inner circumferential surface of the fixing belt. A stay supports the laminated heater. The laminated heater directly heats the fixing belt at a fixing nip formed between the fixing belt and a pressure roller.

### SUMMARY

This specification describes below an improved heating device. In one embodiment, the heating device includes an endless rotator that rotates in a rotation direction. A heater contacts an inner circumferential surface of the endless rotator and extends in an axial direction of the endless rotator. An elastic body is disposed opposite the inner circumferential surface of the endless rotator and disposed downstream from the heater in the rotation direction of the endless rotator. A holder holds the heater and the elastic body. A pressure rotator is disposed opposite the heater and the elastic body via the endless rotator to form a nip between the endless rotator and the pressure rotator. A slide sheet covers a surface of the elastic body. The slide sheet includes an upstream end in the rotation direction of the endless rotator. The upstream end is sandwiched between the heater and the elastic body and between the elastic body and the holder. The upstream end is secured to the holder.

This specification further describes an improved fixing device. In one embodiment, the fixing device includes an endless rotator that rotates in a rotation direction. A heater contacts an inner circumferential surface of the endless rotator and extends in an axial direction of the endless rotator. An elastic body is disposed opposite the inner circumferential surface of the endless rotator and disposed downstream from the heater in the rotation direction of the endless rotator. A holder holds the heater and the elastic body. A pressure rotator is disposed opposite the heater and the elastic body via the endless rotator to form a nip between the endless rotator and the pressure rotator, through which a recording medium bearing a developer is conveyed. A slide sheet covers a surface of the elastic body. The slide sheet includes an upstream end in the rotation direction of the endless rotator. The upstream end is sandwiched between the heater and the elastic body and between the elastic body and the holder. The upstream end is secured to the holder.

This specification further describes an improved image forming apparatus. In one embodiment, the image forming apparatus includes an image forming device that forms an image and the fixing device described above that fixes the image on a recording medium.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1A is a schematic cross-sectional view of an image forming apparatus according to an embodiment of the present disclosure;

FIG. 1B is a schematic cross-sectional view of the image forming apparatus depicted in FIG. 1A, illustrating a principle thereof;

FIG. 2 is a cross-sectional view of a fixing device incorporated in the image forming apparatus depicted in FIG. 1A;

FIG. 3A is a plan view of a heater incorporated in the fixing device depicted in FIG. 2;

FIG. 3B is a cross-sectional view of the heater depicted in FIG. 3A;

FIG. 4A is a cross-sectional view of a heating device according to a first embodiment of the present disclosure, that is incorporated in the fixing device depicted in FIG. 2;

FIG. 4B is a plan view of a slide sheet incorporated in the heating device depicted in FIG. 4A;

FIG. 4C is a cross-sectional view of a heating device as a variation of the heating device depicted in FIG. 4A;

FIG. 5 is a cross-sectional view of a comparative fixing device;

FIG. 6A is a cross-sectional view of a heating device according to a second embodiment of the present disclosure, that is installable in the fixing device depicted in FIG. 2;

FIG. 6B is a perspective view of the heating device depicted in FIG. 6A;

FIG. 6C is a plan view of the slide sheet incorporated in the heating device depicted in FIG. 6A, illustrating one end of the slide sheet;

FIG. 7 is a cross-sectional view of a heating device according to a third embodiment of the present disclosure, that is installable in the fixing device depicted in FIG. 2;

FIG. 8 is a cross-sectional view of a heating device according to a fourth embodiment of the present disclosure, that is installable in the fixing device depicted in FIG. 2;

FIG. 9 is a cross-sectional view of a heating device according to a fifth embodiment of the present disclosure, that is installable in the fixing device depicted in FIG. 2;

FIG. 10A is a plan view of the slide sheet depicted in FIG. 4B and an engagement that engages the slide sheet; and

FIG. 10B is a plan view of a comparative slide sheet.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Referring to drawings, a description is provided of a construction of a heating device, a fixing device incorporating the heating device, and an image forming apparatus (e.g., a laser printer) incorporating the fixing device according to embodiments of the present disclosure.

A laser printer is one example of the image forming apparatus. The image forming apparatus is not limited to the laser printer. For example, the image forming apparatus may be a copier, a facsimile machine, a printer, a printing machine, an inkjet recording apparatus, or a multifunction peripheral (MFP) having at least two of copying, facsimile, printing, scanning, and inkjet recording functions.

In the drawings, identical reference numerals are assigned to identical elements and equivalents and redundant descriptions of the identical elements and the equivalents are summarized or omitted properly. The dimension, material, shape, relative position, and the like of each of the elements are examples and do not limit the scope of this disclosure unless otherwise specified.

According to the embodiments below, a sheet is used as a recording medium.

However, the recording medium is not limited to paper as the sheet. In addition to paper as the sheet, the recording media include an overhead projector (OHP) transparency, cloth, a metal sheet, plastic film, and a prepreg sheet pre-impregnated with resin in carbon fiber.

The recording media also include a medium adhered with a developer or ink, recording paper, and a recording sheet. The sheets include, in addition to plain paper, thick paper, a postcard, an envelope, thin paper, coated paper, art paper, and tracing paper.

Image formation described below denotes forming an image having meaning such as characters and figures and an image not having meaning such as patterns on the medium.

A description is provided of a construction of a laser printer as an image forming apparatus 100.

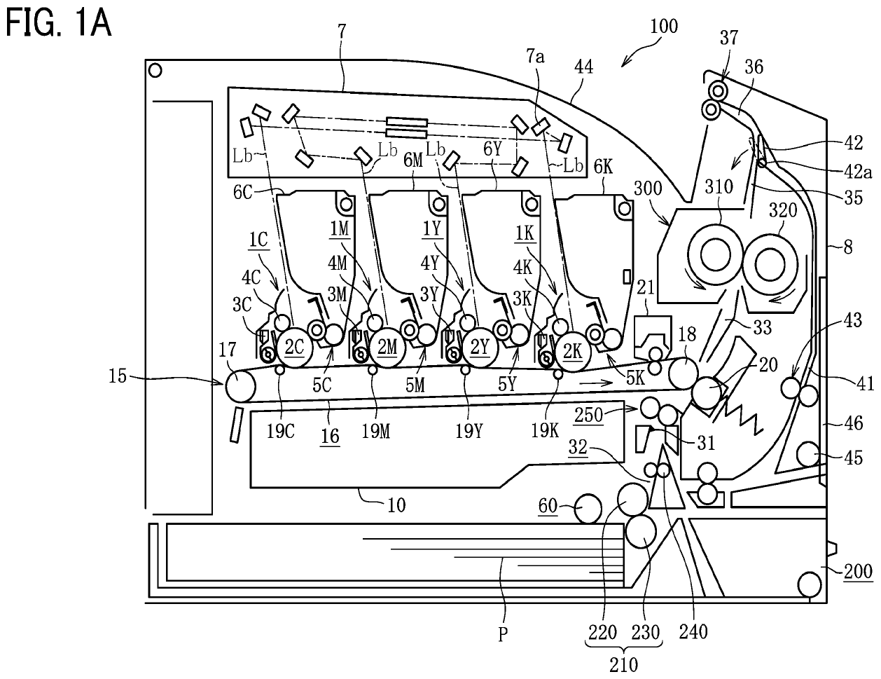

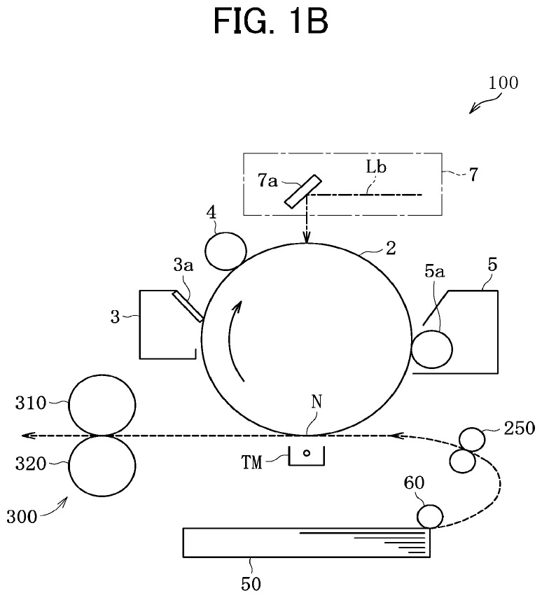

FIG. 1A is a schematic cross-sectional view of the image forming apparatus 100 that incorporates the heating device or a fixing device 300 according to the embodiments of the present disclosure. FIG. 1A schematically illustrates a construction of a color laser printer as one embodiment of the image forming apparatus 100. FIG. 1B is a schematic cross-sectional view of the image forming apparatus 100, illustrating and simplifying a principle or a mechanism of the color laser printer.

As illustrated in FIG. 1A, the image forming apparatus 100 includes four process units 1K, 1Y, 1M, and 1C serving as image forming devices, respectively. The process units 1K, 1Y, 1M, and 1C form black, yellow, magenta, and cyan toner images with developers in black (K), yellow (Y), magenta (M), and cyan (C), respectively, which correspond to color separation components for a color image.

The process units 1K, 1Y, 1M, and 1C have a common construction except that the process units 1K, 1Y, 1M, and 1C include toner bottles 6K, 6Y, 6M, and 6C containing fresh toners in different colors, respectively. Hence, the following describes a construction of a single process unit, that is, the process unit 1K, and a description of a construction of each of other process units, that is, the process units 1Y, 1M, and 1C, is omitted.

The process unit 1K includes an image bearer 2K (e.g., a photoconductive drum), a drum cleaner 3K, and a discharger. The process unit 1K further includes a charger 4K and a developing device 5K. The charger 4K serves as a charging member or a charging device that uniformly charges a surface of the image bearer 2K. The developing device 5K serves as a developing member that develops an electrostatic latent image formed on the image bearer 2K into a visible image. The process unit 1K is detachably attached to a body of the image forming apparatus 100 to replace consumables of the process unit 1K with new ones.

Similarly, the process units 1Y, 1M, and 1C include image bearers 2Y, 2M, and 2C, drum cleaners 3Y, 3M, and 3C, chargers 4Y, 4M, and 4C, and developing devices 5Y, 5M, and 5C, respectively. In FIG. 1B, the image bearers 2K, 2Y, 2M, and 2C, the drum cleaners 3K, 3Y, 3M, and 3C, the chargers 4K, 4Y, 4M, and 4C, and the developing devices 5K, 5Y, 5M, and 5C are indicated as an image bearer 2, a drum cleaner 3, a charger 4, and a developing device 5, respectively.

An exposure device 7 is disposed above the process units 1K, 1Y, 1M, and 1C disposed inside the image forming apparatus 100. The exposure device 7 performs scanning and writing according to image data. For example, the exposure device 7 includes a laser diode that emits a laser beam Lb according to the image data and a mirror 7a that reflects the laser beam Lb to the image bearer 2K so that the laser beam Lb irradiates the image bearer 2K.

According to this embodiment, a transfer device 15 is disposed below the process units 1K, 1Y, 1M, and 1C. The transfer device 15 is equivalent to a transferor TM depicted in FIG. 1B. Primary transfer rollers 19K, 19Y, 19M, and 19C are disposed opposite the image bearers 2K, 2Y, 2M, and 2C, respectively, and in contact with an intermediate transfer belt 16.

The intermediate transfer belt 16 rotates in a state in which the intermediate transfer belt 16 is looped over the primary transfer rollers 19K, 19Y, 19M, and 19C, a driving roller 18, and a driven roller 17. A secondary transfer roller 20 is disposed opposite the driving roller 18 and in contact with the intermediate transfer belt 16. The image bearers 2K, 2Y, 2M, and 2C serve as primary image bearers that bear black, yellow, magenta, and cyan toner images, respectively. The intermediate transfer belt 16 serves as a secondary image bearer that bears a composite toner image (e.g., a color toner image) formed with the black, yellow, magenta, and cyan toner images.

A belt cleaner 21 is disposed downstream from the secondary transfer roller 20 in a rotation direction of the intermediate transfer belt 16. A cleaning backup roller is disposed opposite the belt cleaner 21 via the intermediate transfer belt 16.

A sheet feeder 200 including a tray 50 depicted in FIG. 1B that loads sheets P is disposed in a lower portion of the image forming apparatus 100. The sheet feeder 200 serves as a recording medium supply that contains a plurality of sheets P in a substantial number, that is, a sheaf of sheets P, serving as recording media. The sheet feeder 200 is combined with a sheet feeding roller 60 and a roller pair 210 into a unit. The sheet feeding roller 60 and the roller pair 210 serve as separation-conveyance members that separate an uppermost sheet P from other sheets P and convey the uppermost sheet P.

The sheet feeder 200 is inserted into and removed from the body of the image forming apparatus 100 for replenishment and the like of the sheets P. The sheet feeding roller 60 and the roller pair 210 are disposed above the sheet feeder 200 and convey the uppermost sheet P of the sheaf of sheets P placed in the sheet feeder 200 toward a sheet feeding path 32.

A registration roller pair 250 serving as a conveyor is disposed immediately upstream from the secondary transfer roller 20 in a sheet conveyance direction. The registration roller pair 250 temporarily halts the sheet P sent from the sheet feeder 200. As the registration roller pair 250 temporarily halts the sheet P, the registration roller pair 250 slacks a leading end of the sheet P, correcting skew of the sheet P.

A registration sensor 31 is disposed immediately upstream from the registration roller pair 250 in the sheet conveyance direction. The registration sensor 31 detects passage of the leading end of the sheet P. When a predetermined time period elapses after the registration sensor 31 detects passage of the leading end of the sheet P, the sheet P strikes the registration roller pair 250 and halts temporarily.

Downstream from the sheet feeder 200 in the sheet conveyance direction is a conveying roller 240 that conveys the sheet P conveyed rightward from the roller pair 210 upward. As illustrated in FIG. 1A, the conveying roller 240 conveys the sheet P upward toward the registration roller pair 250.

The roller pair 210 is constructed of a pair of rollers, that is, an upper roller and a lower roller. The roller pair 210 employs a friction reverse roller (FRR) separation system or a friction roller (FR) separation system. According to the FRR separation system, a separating roller (e.g., a reverse roller) is applied with a torque in a predetermined amount in an anti-feeding direction by a driving shaft through a torque limiter. The separating roller is pressed against a feeding roller to form a nip therebetween where the uppermost sheet P is separated from other sheets P. According to the FR separation system, a separating roller (e.g., a friction roller) is supported by a securing shaft via a torque limiter. The separating roller is pressed against a feeding roller to form a nip therebetween where the uppermost sheet P is separated from other sheets P.

According to this embodiment, the roller pair 210 employs the FRR separation system. For example, the roller pair 210 includes a feeding roller 220 and a separating roller 230. The feeding roller 220 is an upper roller that conveys the sheet P to an inside of a machine. The separating roller 230 is a lower roller that is applied with a driving force in a direction opposite a rotation direction of the feeding roller 220 by a driving shaft through a torque limiter.

A biasing member such as a spring biases the separating roller 230 against the feeding roller 220. The driving force applied to the feeding roller 220 is transmitted to the sheet feeding roller 60 through a clutch, thus rotating the sheet feeding roller 60 counterclockwise in FIG. 1A.

After the leading end of the sheet P strikes the registration roller pair 250 and slacks, the registration roller pair 250 conveys the sheet P to a secondary transfer nip (e.g., a transfer nip N depicted in FIG. 1B) formed between the secondary transfer roller 20 and the intermediate transfer belt 16 pressed by the driving roller 18 at a proper time when the secondary transfer roller 20 transfers a color toner image formed on the intermediate transfer belt 16 onto the sheet P. A bias applied at the secondary transfer nip electrostatically transfers the color toner image formed on the intermediate transfer belt 16 onto a desired transfer position on the sheet P sent to the secondary transfer nip precisely.

A post-transfer conveyance path 33 is disposed above the secondary transfer nip formed between the secondary transfer roller 20 and the intermediate transfer belt 16 pressed by the driving roller 18. The fixing device 300 is disposed in proximity to an upper end of the post-transfer conveyance path 33. The fixing device 300 includes a fixing belt 310 and a pressure roller 320. The fixing belt 310 is tubular and serves as an endless rotator or a rotator that accommodates a heater. The pressure roller 320 serves as a pressure rotator or a pressure member that rotates while the pressure roller 320 contacts an outer circumferential surface of the fixing belt 310 with predetermined pressure.

As illustrated in FIG. 1A, a post-fixing conveyance path 35 is disposed above the fixing device 300. At an upper end of the post-fixing conveyance path 35, the post-fixing conveyance path 35 branches to a sheet ejection path 36 and a reverse conveyance path 41. A switcher 42 is disposed at a bifurcation of the post-fixing conveyance path 35. The switcher 42 pivots about a pivot shaft 42a as an axis. A sheet ejection roller pair 37 is disposed in proximity to an outlet edge of the sheet ejection path 36.

One end of the reverse conveyance path 41 is at the bifurcation of the post-fixing conveyance path 35. Another end of the reverse conveyance path 41 joins the sheet feeding path 32. A reverse conveyance roller pair 43 is disposed in a middle of the reverse conveyance path 41. A sheet ejection tray 44 is disposed in an upper portion of the image forming apparatus 100. The sheet ejection tray 44 includes a recess directed inward in the image forming apparatus 100.

A powder container 10 (e.g., a toner container) is interposed between the transfer device 15 and the sheet feeder 200. The powder container 10 is detachably attached to the body of the image forming apparatus 100.

The image forming apparatus 100 according to this embodiment secures a predetermined distance from the sheet feeding roller 60 to the secondary transfer roller 20 to convey the sheet P. Hence, the powder container 10 is situated in a dead space defined by the predetermined distance, downsizing the image forming apparatus 100 entirely.

A transfer cover 8 is disposed above the sheet feeder 200 at a front of the image forming apparatus 100 in a drawing direction of the sheet feeder 200. As an operator (e.g., a user and a service engineer) opens the transfer cover 8, the operator inspects an inside of the image forming apparatus 100. The transfer cover 8 mounts a bypass tray 46 and a bypass sheet feeding roller 45 used for a sheet P manually placed on the bypass tray 46 by the operator.

A description is provided of operations of the image forming apparatus 100, that is, the laser printer.

Referring to FIG. 1A, the following describes basic operations of the image forming apparatus 100 according to the embodiments, which has the construction described above to perform image formation.

First, a description is provided of operations of the image forming apparatus 100 to print on one side of a sheet P.

As illustrated in FIG. 1A, the sheet feeding roller 60 rotates according to a sheet feeding signal sent from a controller of the image forming apparatus 100. The sheet feeding roller 60 separates an uppermost sheet P from other sheets P of a sheaf of sheets P loaded in the sheet feeder 200 and feeds the uppermost sheet P to the sheet feeding path 32.

When the leading end of the sheet P sent by the sheet feeding roller 60 and the roller pair 210 reaches a nip of the registration roller pair 250, the registration roller pair 250 slacks and halts the sheet P temporarily. The registration roller pair 250 conveys the sheet P to the secondary transfer nip at an optimal time in synchronism with a time when the secondary transfer roller 20 transfers a color toner image formed on the intermediate transfer belt 16 onto the sheet P while the registration roller pair 250 corrects skew of the leading end of the sheet P.

In order to feed a sheaf of sheets P placed on the bypass tray 46, the bypass sheet feeding roller 45 conveys the sheaf of sheets P loaded on the bypass tray 46 one by one from an uppermost sheet P. The sheet P is conveyed through a part of the reverse conveyance path 41 to the nip of the registration roller pair 250. Thereafter, the sheet P is conveyed similarly to the sheet P conveyed from the sheet feeder 200.

The following describes processes for image formation with one process unit, that is, the process unit 1K, and a description of processes for image formation with other process units, that is, the process units 1Y, 1M, and 1C, is omitted.

First, the charger 4K uniformly charges the surface of the image bearer 2K at a high electric potential. The exposure device 7 emits a laser beam Lb that irradiates the surface of the image bearer 2K according to image data.

The electric potential of an irradiated portion on the surface of the image bearer 2K, which is irradiated with the laser beam Lb, decreases, forming an electrostatic latent image on the image bearer 2K. The developing device 5K includes a developer bearer 5a depicted in FIG. 1B that bears a developer containing toner. Fresh black toner supplied from the toner bottle 6K is transferred onto a portion on the surface of the image bearer 2K, which bears the electrostatic latent image, through the developer bearer 5a.

The surface of the image bearer 2K transferred with the black toner bears a black toner image developed with the black toner. The primary transfer roller 19K transfers the black toner image formed on the image bearer 2K onto the intermediate transfer belt 16.

A cleaning blade 3a depicted in FIG. 1B of the drum cleaner 3K removes residual toner failed to be transferred onto the intermediate transfer belt 16 and therefore adhered on the surface of the image bearer 2K therefrom. The removed residual toner is conveyed by a waste toner conveyor and collected into a waste toner container disposed inside the process unit 1K. The discharger removes residual electric charge from the image bearer 2K from which the drum cleaner 3K has removed the residual toner.

Similarly, in the process units 1Y, 1M, and 1C, yellow, magenta, and cyan toner images are formed on the image bearers 2Y, 2M, and 2C, respectively. The primary transfer rollers 19Y, 19M, and 19C transfer the yellow, magenta, and cyan toner images formed on the image bearers 2Y, 2M, and 2C, respectively, onto the intermediate transfer belt 16 such that the yellow, magenta, and cyan toner images are superimposed on the intermediate transfer belt 16.

The black, yellow, magenta, and cyan toner images transferred and superimposed on the intermediate transfer belt 16 travel to the secondary transfer nip formed between the secondary transfer roller 20 and the intermediate transfer belt 16 pressed by the driving roller 18. On the other hand, the registration roller pair 250 resumes rotation at a predetermined time while sandwiching a sheet P that strikes the registration roller pair 250. The registration roller pair 250 conveys the sheet P to the secondary transfer nip formed between the secondary transfer roller 20 and the intermediate transfer belt 16 at a time when the secondary transfer roller 20 transfers the black, yellow, magenta, and cyan toner images superimposed on the intermediate transfer belt 16 properly. Thus, the secondary transfer roller 20 transfers the black, yellow, magenta, and cyan toner images superimposed on the intermediate transfer belt 16 onto the sheet P conveyed by the registration roller pair 250, forming a color toner image on the sheet P.

The sheet P transferred with the color toner image is conveyed to the fixing device 300 through the post-transfer conveyance path 33. The fixing belt 310 and the pressure roller 320 sandwich the sheet P conveyed to the fixing device 300 and fix the unfixed color toner image on the sheet P under heat and pressure. The sheet P bearing the fixed color toner image is conveyed from the fixing device 300 to the post-fixing conveyance path 35.

When the sheet P is sent out of the fixing device 300, the switcher 42 opens the upper end of the post-fixing conveyance path 35 and a vicinity thereof as illustrated with a solid line in FIG. 1A. The sheet P sent out of the fixing device 300 is conveyed to the sheet ejection path 36 through the post-fixing conveyance path 35. The sheet ejection roller pair 37 sandwiches the sheet P sent to the sheet ejection path 36 and is driven and rotated to eject the sheet P onto the sheet ejection tray 44, thus finishing printing on one side of the sheet P.

Next, a description is provided of operations of the image forming apparatus 100 to perform duplex printing.

Similarly to printing on one side of the sheet P, the fixing device 300 sends out the sheet P to the sheet ejection path 36. In order to perform duplex printing, the sheet ejection roller pair 37 is driven and rotated to convey a part of the sheet P to an outside of the image forming apparatus 100.

When a trailing end of the sheet P has passed through the sheet ejection path 36, the switcher 42 pivots about the pivot shaft 42a as illustrated with a dotted line in FIG. 1A, closing the upper end of the post-fixing conveyance path 35. Approximately simultaneously with closing of the upper end of the post-fixing conveyance path 35, the sheet ejection roller pair 37 rotates in a direction opposite a direction in which the sheet ejection roller pair 37 conveys the sheet P onto the outside of the image forming apparatus 100, thus conveying the sheet P to the reverse conveyance path 41.

The sheet P conveyed to the reverse conveyance path 41 travels to the registration roller pair 250 through the reverse conveyance roller pair 43. The registration roller pair 250 conveys the sheet P to the secondary transfer nip at a proper time when the secondary transfer roller 20 transfers black, yellow, magenta, and cyan toner images superimposed on the intermediate transfer belt 16 onto a back side of the sheet P, which is transferred with no toner image, that is, in synchronism with reaching of the black, yellow, magenta, and cyan toner images to the secondary transfer nip.

While the sheet P passes through the secondary transfer nip, the secondary transfer roller 20 and the driving roller 18 transfer the black, yellow, magenta, and cyan toner images onto the back side of the sheet P, which is transferred with no toner image, thus forming a color toner image on the sheet P. The sheet P transferred with the color toner image is conveyed to the fixing device 300 through the post-transfer conveyance path 33.

In the fixing device 300, the fixing belt 310 and the pressure roller 320 sandwich the sheet P conveyed to the fixing device 300 and fix the unfixed color toner image on the back side of the sheet P under heat and pressure. The sheet P bearing the color toner image fixed on both sides, that is, a front side and the back side, of the sheet P, is conveyed from the fixing device 300 to the post-fixing conveyance path 35.

When the sheet P is sent out of the fixing device 300, the switcher 42 opens the upper end of the post-fixing conveyance path 35 and the vicinity thereof as illustrated with the solid line in FIG. 1A. The sheet P sent out of the fixing device 300 is conveyed to the sheet ejection path 36 through the post-fixing conveyance path 35. The sheet ejection roller pair 37 sandwiches the sheet P sent to the sheet ejection path 36 and is driven and rotated to eject the sheet P onto the sheet ejection tray 44, thus finishing duplex printing on the sheet P.

After the secondary transfer roller 20 transfers the black, yellow, magenta, and cyan toner images superimposed on the intermediate transfer belt 16 onto the sheet P, residual toner adheres to the intermediate transfer belt 16. The belt cleaner 21 removes the residual toner from the intermediate transfer belt 16. The residual toner removed from the intermediate transfer belt 16 is conveyed by the waste toner conveyor and collected into the powder container 10.

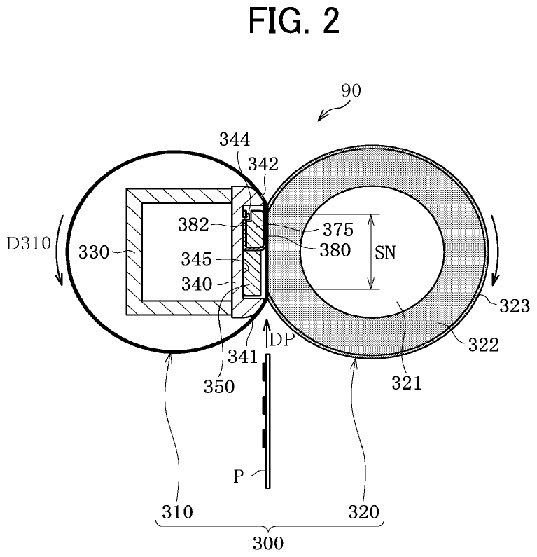

Referring to FIGS. 2, 3A, 3B, 4A, 4B, 4C, 6A, 6B, 6C, 7, 8, 9, 10A, and 10B, a description is provided of a construction of each of heating devices 90, 90S, 90T, 90U, 90V, and 90W and the fixing device 300 according to first to sixth embodiments of the present disclosure, respectively.

Each of the heating devices 90, 90S, 90T, 90U, 90V, and 90W is installable in the fixing device 300. As illustrated in FIG. 2, the fixing device 300 includes a heater 350 that heats the fixing belt 310.

A description is provided of the construction of the fixing device 300 including the heating device 90 according to the first embodiment of the present disclosure.

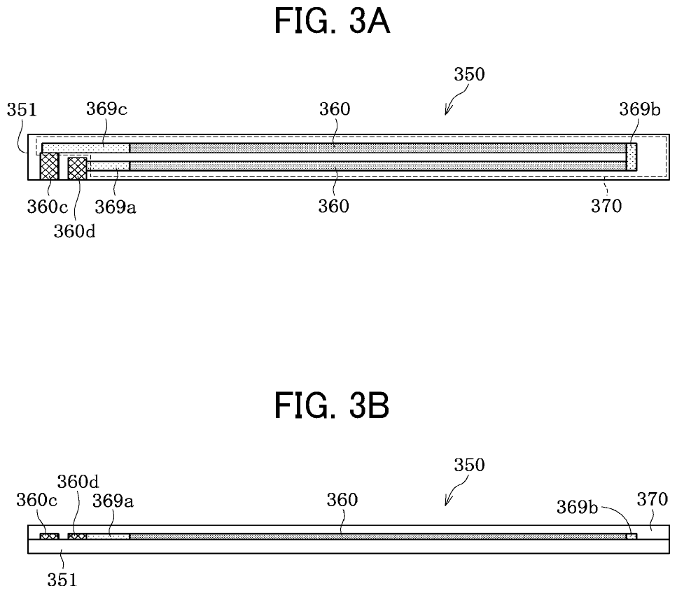

As illustrated in FIG. 2, the fixing device 300 includes the fixing belt 310 that is thin and tubular and has a decreased thermal capacity and the pressure roller 320. As a sheet P that bears a toner image and is conveyed in a sheet conveyance direction DP passes through a fixing nip SN formed between the fixing belt 310 and the pressure roller 320, the fixing belt 310 and the pressure roller 320 sandwich the sheet P and fix the toner image on the sheet P under heat. While the fixing belt 310 rotates in a rotation direction D310 and slides over an insulating layer 370 covering heat generators 360 as illustrated in FIG. 3A, the heat generators 360 heat the fixing belt 310.

A detailed description is now given of a construction of the fixing belt 310.

The fixing belt 310 includes a tubular base that is made of polyimide (PI) and has an outer diameter of 25 mm and a thickness in a range of from 50 micrometers to 70 micrometers, for example. The fixing belt 310 further includes a release layer serving as an outermost surface layer. The release layer is made of fluororesin, such as tetrafluoroethylene-perfluoroalkylvinylether copolymer (PFA) and polytetrafluoroethylene (PTFE), and has a thickness in a range of from 5 micrometers to 20 micrometers to enhance durability of the fixing belt 310 and facilitate separation of the sheet P and a foreign substance from the fixing belt 310. Optionally, an elastic layer that is made of rubber or the like and has a thickness in a range of from 100 micrometers to 300 micrometers may be interposed between the base and the release layer.

The base of the fixing belt 310 may be made of heat resistant resin such as polyetheretherketone (PEEK) or metal such as nickel (Ni) and SUS stainless steel, instead of polyimide. An inner circumferential surface of the fixing belt 310 may be coated with polyimide, PTFE, or the like to produce a slide layer. The tubular base made of SUS stainless steel achieves sufficient strength even with a thickness in a range of from 20 micrometers to 40 micrometers.

A detailed description is now given of a construction of the pressure roller 320.

The pressure roller 320 has an outer diameter of 25 mm, for example. The pressure roller 320 includes a cored bar 321, an elastic layer 322, and a release layer 323. The cored bar 321 is solid and made of metal such as iron. The elastic layer 322 coats the cored bar 321. The release layer 323 coats an outer surface of the elastic layer 322. The elastic layer 322 is made of silicone rubber and has a thickness of 3.5 mm, for example.

In order to facilitate separation of the sheet P and the foreign substance from the pressure roller 320, the release layer 323 that is made of fluororesin and has a thickness of about 40 micrometers, for example, is preferably disposed on the outer surface of the elastic layer 322. A biasing member presses the pressure roller 320 against the fixing belt 310.

A stay 330 serving as a support and a holder 340 serving as a holder are disposed inside a loop formed by the fixing belt 310 and extended in an axial direction of the fixing belt 310. The stay 330 includes a channel made of metal. Both lateral ends of the stay 330 in a longitudinal direction thereof are supported by side plates of the heating device 90, respectively. The stay 330 receives pressure from the pressure roller 320 precisely to form the fixing nip SN stably.

The holder 340 includes an upstream guide 341 disposed at an entry to the fixing nip SN and a downstream guide 342 disposed at an exit of the fixing nip SN. Each of the upstream guide 341 and the downstream guide 342 is an arc in cross section and contacts the inner circumferential surface of the fixing belt 310. The upstream guide 341 and the downstream guide 342 guide the fixing belt 310 in a tangential direction tangential to the fixing nip SN. The holder 340 includes a recess 345 (e.g., a groove) that accommodates and holds a base 351 of the heater 350 depicted in FIG. 3A. The stay 330 supports a rear face of the holder 340. The holder 340 is preferably made of heat resistant resin having a decreased thermal conductivity, such as liquid crystal polymer (LCP). Accordingly, the holder 340 reduces conduction of heat thereto, improving heating of the fixing belt 310.

In order to prevent contact with a high temperature portion of the heater 350, the holder 340 has a shape that supports the heater 350 at two positions in proximity to both ends of the heater 350, respectively, in a short direction thereof. Accordingly, the holder 340 reduces conduction of heat thereto further, improving heating of the fixing belt 310.

The heater 350 (e.g., a laminated heater) includes the heat generators 360 (e.g., resistive heat generators). As illustrated in FIGS. 3A and 3B, the heat generators 360 are mounted on the base 351. The base 351 includes an elongate, thin metal plate and an insulator that coats the metal plate.

The base 351 is preferably made of aluminum, stainless steel, or the like that is available at reduced costs. Alternatively, instead of metal, the base 351 may be made of ceramic such as alumina and aluminum nitride or a nonmetallic material that has an increased heat resistance and an increased insulation such as glass and mica.

In order to improve evenness of heat generated by the heater 350 so as to enhance quality of an image formed on a sheet P, the base 351 may be made of a material that has an increased thermal conductivity such as copper, graphite, and graphene. According to this embodiment, the base 351 is made of alumina and has a short width of 8 mm, a longitudinal length of 270 mm, and a thickness of 1.0 mm.

As illustrated in FIG. 3A, specifically, the heat generators 360 mounted on the base 351 are extended linearly in a longitudinal direction of the base 351 and are arranged in series and in two lines in parallel to each other. One lateral end of one of the heat generators 360 arranged in two lines is connected to an electrode 360c through a feeder 369c. One lateral end of another one of the heat generators 360 is connected to an electrode 360d through a feeder 369a. The feeders 369a and 369c, having a decreased resistance value, are disposed on one lateral end of the base 351 and extended in the longitudinal direction of the base 351. The electrodes 360c and 360d supply power to the heat generators 360, respectively. The electrodes 360c and 360d are coupled to a power supply including an alternating current power supply.

Another lateral end of one of the heat generators 360 is connected to another lateral end of another one of the heat generators 360 through a feeder 369b such that one of the heat generators 360, that extends in the longitudinal direction of the base 351 and in a direction directed to the feeder 369b, is turned at the feeder 369b and another one of the heat generators 360 extends in the longitudinal direction of the base 351 and in an opposite direction. The feeder 369b, having a decreased resistance value, is disposed on another lateral end of the base 351 in the longitudinal direction thereof and extended in the short direction of the base 351. Each of the heat generators 360, the electrodes 360c and 360d, and the feeders 369a, 369b, and 369c is produced by screen printing to have a predetermined line width and a predetermined thickness.

The heat generators 360 are produced as below. Silver (Ag) or silver-palladium (AgPd) and glass powder and the like are mixed into paste. The paste coats the base 351 by screen printing or the like. Thereafter, the base 351 is subject to firing. For example, each of the heat generators 360 has a resistance value of 10Ω at an ambient temperature. Alternatively, the heat generators 360 may be made of a resistive material such as a silver alloy (AgPt) and ruthenium oxide (RuO₂).

A thin overcoat layer or the insulating layer 370 covers a surface of each of the heat generators 360 and the feeders 369a, 369b, and 369c. The insulating layer 370 attains insulation between the fixing belt 310 and the heat generators 360 and between the fixing belt 310 and the feeders 369a, 369b, and 369c while facilitating sliding of the fixing belt 310 over the insulating layer 370.

For example, the insulating layer 370 is made of heat resistant glass and has a thickness of 75 micrometers. The heat generators 360 heat the fixing belt 310 that contacts the insulating layer 370 by conduction of heat, increasing the temperature of the fixing belt 310 so that the fixing belt 310 heats and fixes the unfixed toner image on the sheet P conveyed through the fixing nip SN.

The inner circumferential surface of the fixing belt 310 is applied with a lubricant that facilitates sliding of the fixing belt 310 over the heater 350. The lubricant is silicone oil having heat resistance and a predetermined kinetic viscosity. For example, the lubricant is preferably amino-modified silicone oil having an enhanced wettability or methylphenyl silicone oil having an enhanced heat resistance. In order to improve heat resistance, an antioxidant in a slight amount may be added to the silicone oil.

For example, the lubricant may be grease, dimethyl silicone oil, organometallic salt-added dimethyl silicone oil, hindered amine-added dimethyl silicone oil, dimethyl silicone oil added with organometallic salt and hindered amine, methylphenyl silicone oil, organometallic salt-added amino-modified silicone oil, hindered amine-added amino-modified silicone oil, perfluoro polyether oil, or the like.

As illustrated in FIG. 2, an elastic body 375 is disposed downstream from and abutted on the heater 350 (e.g., the laminated heater) that incorporates the heat generators 360 in the sheet conveyance direction DP or the rotation direction D310 of the fixing belt 310. The elastic body 375 is rectangular in cross section in a short direction thereof and extended in a longitudinal direction of the heater 350.

The elastic body 375 is made of silicone rubber having an Asker C hardness in a range of from 40 degrees to 50 degrees and a predetermined thickness in a range of from 2 mm to 3 mm, for example. In order to improve fitting to a height of the toner image on the sheet P, the elastic body 375 may be made of silicone sponge, heat resistant nonwoven fabric, felt, or the like that has the Asker C hardness in a range of from 20 degrees to 40 degrees.

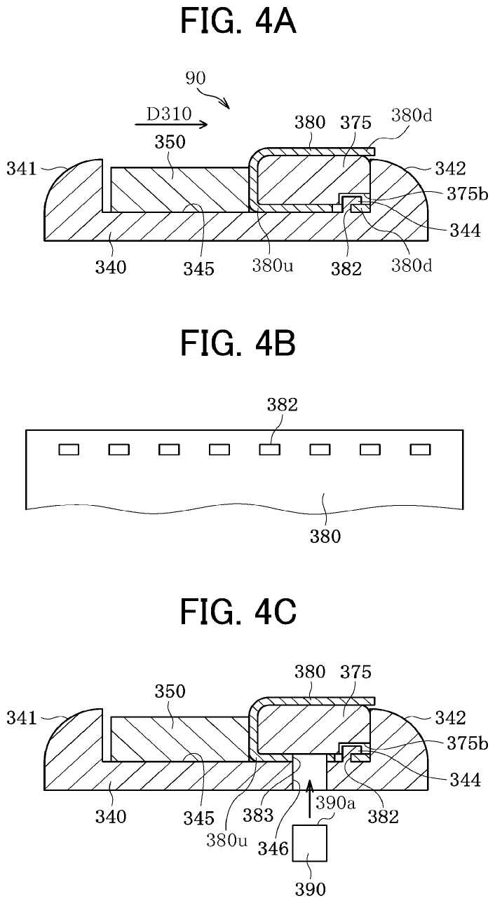

FIG. 4A is a cross-sectional view of the heating device 90. FIG. 4B is a plan view of a slide sheet 380 incorporated in the heating device 90 depicted in FIG. 4A. FIG. 4C is a cross-sectional view of a heating device as a variation of the heating device 90 depicted in FIG. 4A.

As illustrated in FIG. 4A, the recess 345 of the holder 340 accommodates the elastic body 375 in a downstream portion of the heater 350 in the rotation direction D310 of the fixing belt 310, thus positioning the elastic body 375. The slide sheet 380 covers a surface of the elastic body 375. As illustrated in FIG. 4A, an upstream end 380u of the slide sheet 380 in the sheet conveyance direction DP or the rotation direction D310 of the fixing belt 310 is sandwiched between the elastic body 375 and the heater 350 and turned downstream in the sheet conveyance direction DP or the rotation direction D310 of the fixing belt 310 along a bottom face of the elastic body 375. For example, the upstream end 380u of the slide sheet 380 in the sheet conveyance direction DP or the rotation direction D310 of the fixing belt 310 is sandwiched between the elastic body 375 and the heater 350 and between the elastic body 375 and the holder 340.

The slide sheet 380 is a non-porous sheet made of heat resistant resin. The non-porous sheet has no holes impregnated with a lubricant. The heat resistant resin has sufficient heat resistance against a fixing temperature at which a toner image is fixed on a sheet P. For example, the heat resistant resin includes thermosetting polyimide, thermoplastic polyimide, polyamide, polyamide imide, silicone resin, and fluororesin.

On the other hand, a downstream end 380d of the slide sheet 380 in the sheet conveyance direction DP or the rotation direction D310 of the fixing belt 310 is disposed opposite a downstream end of the holder 340 in the sheet conveyance direction DP or the rotation direction D310 of the fixing belt 310 in a state in which the downstream end 380d of the slide sheet 380 is sandwiched between the fixing belt 310 and the elastic body 375. The downstream end 380d of the slide sheet 380 is not a fixed end but a free end, facilitating installation of the slide sheet 380. The area of the slide sheet 380 is minimized, reducing manufacturing costs.

While the fixing belt 310 rotates in the rotation direction D310 in a state in which the fixing belt 310 slides over the heater 350 frictionally, the fixing belt 310 exerts a downstream force in the rotation direction D310 to the heat generators 360 of the heater 350 and the slide sheet 380.

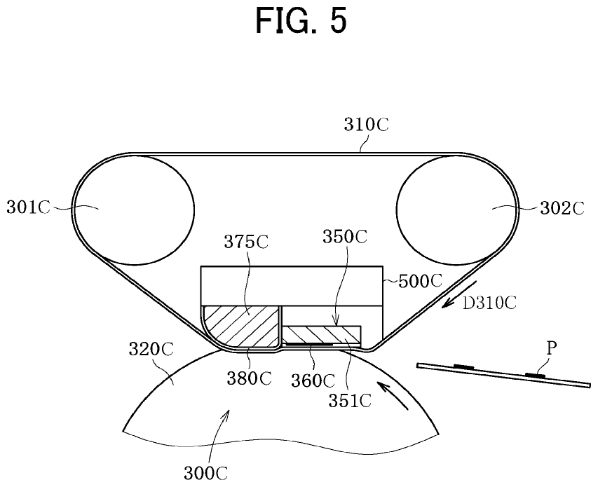

Referring to FIG. 5, a description is provided of a construction of a fixing device 300C as a comparative example.

The fixing device 300C includes a thin, fixing belt 310C having a decreased thermal capacity. The fixing belt 310C is looped over rollers 301C and 302C. A laminated heater 350C constructed of a base 351C and a resistive heat generator 360C heats an inner circumferential surface of the fixing belt 310C. A stay 500C supports the laminated heater 350C. The laminated heater 350C directly heats the fixing belt 310C at a fixing nip formed between the fixing belt 310C and a pressure roller 320C.

With the fixing device 300C employing the laminated heater 350C, since the laminated heater 350C is platy, the laminated heater 350C may not exert sufficient pressure to toner melted and softened at a downstream half part of the fixing nip in a rotation direction D310C of the fixing belt 310C. When the fixing device 300C fixes a color toner image on a sheet P, for example, insufficient pressure may cause faulty mixing of colors (e.g., black, yellow, magenta, and cyan) and faulty fixing.

To address this circumstance, an elastic body 375C disposed opposite the downstream half part of the fixing nip retains sufficient pressure. A slide sheet 3 80C covers a surface of the elastic body 375C. The slide sheet 380C reduces friction between the elastic body 375C and the fixing belt 310C while the fixing belt 310C slides over the elastic body 375C. Alternatively, a low friction agent may coat the surface of the elastic body 375C to reduce friction between the elastic body 375C and the fixing belt 310C while the fixing belt 310C slides over the elastic body 375C. However, the slide sheet 380C is often used to improve durability and reliability. However, if the slide sheet 380C covers the elastic body 375C, the slide sheet 380C may be secured to the elastic body 375C disadvantageously.

For example, an upstream end of the slide sheet 380C in the rotation direction D310C of the fixing belt 310C is sandwiched between the laminated heater 350C and the elastic body 375C. However, the upstream end of the slide sheet 380C may not be secured to the elastic body 375C precisely. Since a gap is produced between the laminated heater 350C and the elastic body 375C, the gap may vary pressure exerted to the sheet P at the fixing nip, causing faulty fixing and creasing the sheet P.

If the laminated heater 350C shifts downstream in the rotation direction D310C of the fixing belt 310C due to friction between the laminated heater 350C and the fixing belt 310C, the laminated heater 350C may deform an upstream end of the elastic body 375C in the rotation direction D310C of the fixing belt 310C partially. The deformed upstream end of the elastic body 375C may lift and crease the slide sheet 380C partially. Accordingly, the slide sheet 380C may increase friction between the elastic body 375C and the fixing belt 310C and driving torque of the fixing belt 310C substantially.

If the slide sheet 380C is secured to the elastic body 375C insufficiently in the fixing device 300C illustrated in FIG. 5, the slide sheet 380C may shift downstream in the rotation direction D310C of the fixing belt 310C. Accordingly, the upstream end of the elastic body 375C in the rotation direction D310C of the fixing belt 310C may be bulged and deformed. A part of the slide sheet 380C may be lifted and deformed into creases. Consequently, the deformed upstream end of the elastic body 375C and the deformed part of the slide sheet 380C may exert pressure greater than predetermined pressure to a part of the fixing nip formed between the fixing belt 310C and the pressure roller 320C, thus increasing friction between the inner circumferential surface of the fixing belt 310C and the elastic body 375C and driving torque of the fixing belt 310C which may result in faulty fixing.

To address this circumstance, according to the first embodiment of the present disclosure, as illustrated in FIGS. 2 and 4A, an engagement 344 secures the upstream end 380u of the slide sheet 380 to the elastic body 375 precisely. Conversely, in the fixing device 300C depicted in FIG. 5, the upstream end of the slide sheet 380C in the rotation direction D310C of the fixing belt 310C may not be secured to the elastic body 375C precisely with pressure exerted by the heater 350C and the elastic body 375C that sandwich the slide sheet 380C. As illustrated in FIG. 4A, a notch 375b is disposed on a bottom of the elastic body 375 and is retracted from the engagement 344. For example, the notch 375b accommodates the engagement 344. Alternatively, if the elastic body 375 has a low rubber hardness degree that is smaller than 50 Hs, the engagement 344 may be pressed into the elastic body 375 without the notch 375b.

The engagement 344 is molded with the holder 340 and mounted on a bottom face of a downstream portion of the recess 345 of the holder 340. In order to prevent the slide sheet 380 from dropping from the holder 340, the engagement 344 has an L-shape in cross section or is bent downstream in the rotation direction D310 of the fixing belt 310 to have a hook shape. On the other hand, the upstream end 380u of the slide sheet 380 in the rotation direction D310 of the fixing belt 310 is sandwiched between the heater 350 and the elastic body 375 and turned downstream in the rotation direction D310 of the fixing belt 310 along the bottom face of the elastic body 375. A turned end of the slide sheet 380 engages the engagement 344.

As illustrated in FIG. 4B, a plurality of rectangular holes 382 is disposed or arranged in the upstream end 380u of the slide sheet 380 in the rotation direction D310 of the fixing belt 310 with an identical gap between adjacent ones of the rectangular holes 382 in the longitudinal direction of the heater 350. The engagement 344 of the holder 340 is inserted into and engaged with the rectangular hole 382. As illustrated in FIG. 4A, the upstream end 380u of the slide sheet 380 is secured to the holder 340, preventing the upstream end 380u of the slide sheet 380 from being lifted partially and deformed into creases precisely. Accordingly, while the fixing belt 310 rotates in the rotation direction D310, the fixing belt 310 slides from the heater 350 to the elastic body 375 smoothly.

Additionally, the upstream end 380u of the slide sheet 380 is sandwiched between the heater 350 and the elastic body 375 with no gap between the heater 350 and the slide sheet 380 and between the elastic body 375 and the slide sheet 380, preventing a decreased load applied to the fixing nip SN, that might be caused by the gap between the heater 350 and the elastic body 375. If the decreased load is applied to a part of the fixing nip SN, the fixing belt 310 is subject to increase in abrasion of the inner circumferential surface of the fixing belt 310 and increase in driving torque.

A method for securing the slide sheet 380 to the holder 340 is not limited to a method using the engagement 344. Various methods or members may be used to secure the slide sheet 380 to the holder 340. For example, a screw is screwed in the upstream end 380u of the slide sheet 380 and the holder 340 or the upstream end 380u of the slide sheet 380 is secured to the holder 340 with an adhesive.

A height of the elastic body 375 is preferably higher than a height of the insulating layer 370 of the heater 350 slightly. For example, a top face of the elastic body 375 protrudes toward the pressure roller 320 beyond a surface of the insulating layer 370. Thus, the elastic body 375 exerts substantial pressure to the fixing belt 310.

With the fixing device 300 employing the heater 350 as the laminated heater, the heater 350 may not exert sufficient pressure to toner melted and softened at a downstream half part of the fixing nip SN in the rotation direction D310 of the fixing belt 310. To address this circumstance, as described above, the elastic body 375 protrudes toward the pressure roller 320 beyond the heater 350, preventing faulty mixing of colors (e.g., black, yellow, magenta, and cyan) and faulty fixing when the fixing device 300 fixes a color toner image on a sheet P, for example.

Conversely, the height of the insulating layer 370 of the heater 350 may be higher than the height of the elastic body 375. Accordingly, the elastic body 375 does not dam the lubricant applied on the inner circumferential surface of the fixing belt 310 at a downstream end of the heater 350 in the sheet conveyance direction DP or the rotation direction D310 of the fixing belt 310, preventing the lubricant from moving and leaking outboard in the axial direction of the fixing belt 310.

A first temperature sensor used to control the heater 350 is interposed between the heater 350 and the holder 340. The first temperature sensor is disposed opposite a center of the heater 350 in the longitudinal direction thereof. A second temperature sensor may be provided separately from the first temperature sensor. The second temperature sensor detects the temperature of the elastic body 375 to measure an amount of heat stored in the fixing device 300.

The fixing device 300 is cool when the fixing device 300 is warmed up at the opening time of an office where the image forming apparatus 100 is located, for example. The fixing device 300 is warmed sufficiently in the daytime while the fixing device 300 is used frequently. Thus, the amount of heat stored in the fixing device 300 varies depending on the time. To address this circumstance, the second temperature sensor detects the amount of heat stored in the fixing device 300 to control the temperature of the fixing belt 310 appropriately. The second temperature sensor is also preferably disposed opposite the center of the heater 350 in the longitudinal direction thereof.

If the second temperature sensor is installed into the fixing device 300, as illustrated in FIG. 4C, the holder 340 is provided with a first through hole 346 through which a second temperature sensor 390 is inserted. A second through hole 383 penetrates through the upstream end 380u of the slide sheet 380. The second through hole 383 is adjacent to the rectangular hole 382. A tip portion 390a of the second temperature sensor 390 is inserted into the second through hole 383 penetrating through the slide sheet 380 and brought into contact with the bottom face of the elastic body 375.

A description is provided of the construction of the heating device 90S according to the second embodiment of the present disclosure.

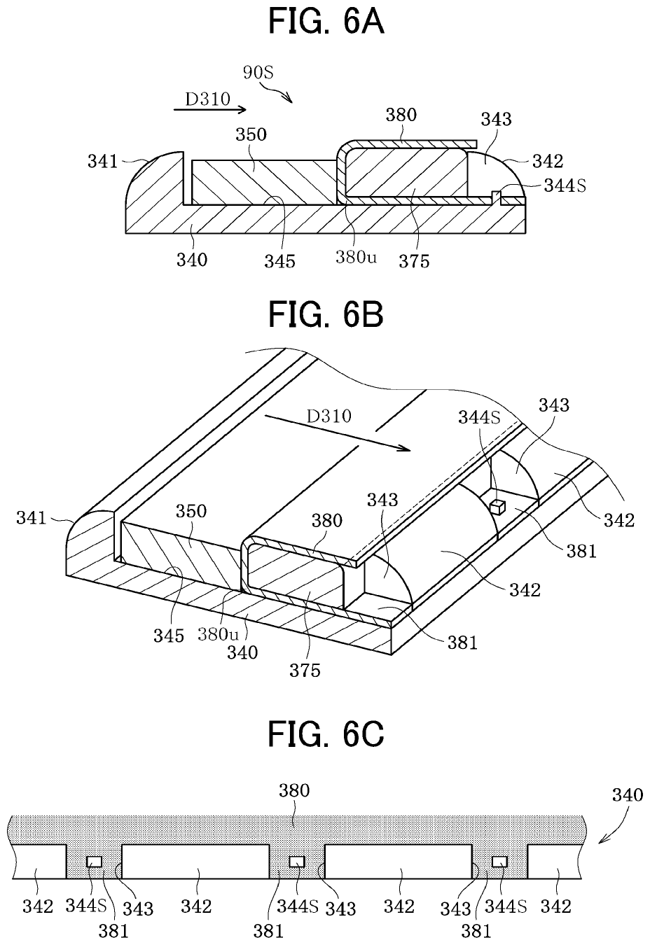

FIGS. 6A, 6B, and 6C illustrate the heating device 90S according to the second embodiment of the present disclosure. According to the second embodiment, engagements 344S that secure the upstream end 380u of the slide sheet 380 to the holder 340 are disposed opposite the downstream guide 342 in a longitudinal direction of the slide sheet 380. For example, a plurality of notches 343 is arranged in the downstream guide 342 with an identical gap between adjacent ones of the notches 343 in the longitudinal direction of the heater 350. The engagements 344S are mounted on bottoms of the notches 343, respectively. For example, the notches 343 accommodate the engagements 344S, respectively.

On the other hand, as illustrated in FIG. 6C, a plurality of rectangular tongues 381 is disposed or arranged in the upstream end 380u of the slide sheet 380 with an identical gap between adjacent ones of the rectangular tongues 381 in the longitudinal direction of the slide sheet 380. Each of the rectangular tongues 381 has a size accommodated in the notch 343. The engagement 344S is inserted into and engaged with a rectangular hole disposed in the rectangular tongue 381. Other construction of the heating device 90S is equivalent to that of the heating device 90 according to the first embodiment depicted in FIGS. 4A, 4B, and 4C.

FIG. 6B illustrates the engagement 344S that is a prism as one example. Alternatively, like the engagement 344 depicted in FIGS. 4A and 4C, the engagement 344S may have an L-shape in cross section or may be bent downstream in the rotation direction D310 of the fixing belt 310 to have a hook shape. The engagements 344S are arranged with the downstream guide 342, downsizing the holder 340 in a short direction thereof and facilitating downsizing of the heating device 90S.

The heating device 90S does not incorporate the notch 375b that is disposed on the bottom of the elastic body 375 and is retracted from the engagement 344 depicted in FIGS. 4A and 4C. Thus, the heating device 90S advantageously evens pressure exerted between the elastic body 375 and the fixing belt 310 at the fixing nip SN.

While the fixing belt 310 rotates in the rotation direction D310 and slides over the heater 350 and the slide sheet 380 covering the elastic body 375 frictionally, the fixing belt 310 exerts a downstream force in the rotation direction D310 to the heater 350, the slide sheet 380, and the elastic body 375. An inner face of the downstream guide 342 contacts a downstream end of the elastic body 375 in the rotation direction D310 of the fixing belt 310. Accordingly, the downstream guide 342 suppresses shifting of the elastic body 375 and the heater 350 downstream in the rotation direction D310 of the fixing belt 310.

As illustrated in FIG. 6B, an edge of the notch 343 disposed in the downstream guide 342 is preferably chamfered to define a C-shaped face or a round face. The notch 343 that is chamfered prevents the inner circumferential surface of the fixing belt 310 from being damaged by the edge of the notch 343 when the fixing belt 310 contacts the edge of the notch 343.

A description is provided of the construction of the heating device 90T according to the third embodiment of the present disclosure.

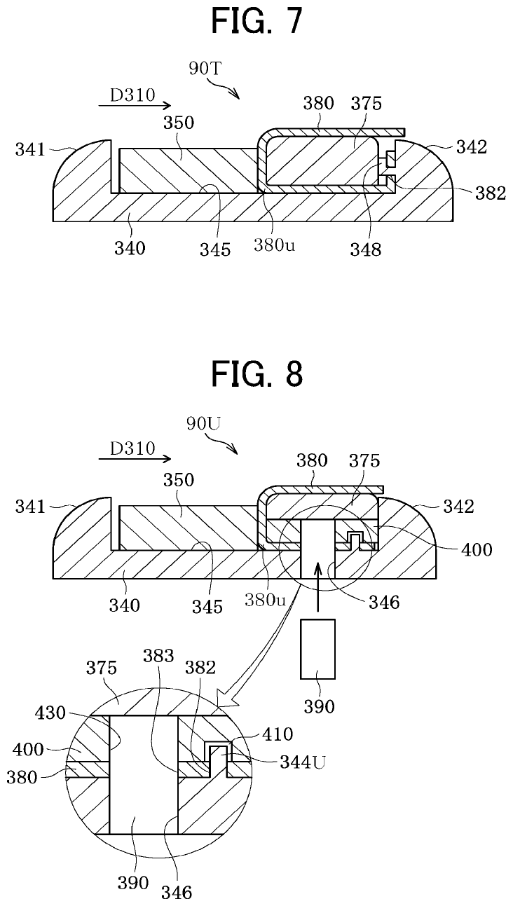

FIG. 7 illustrates the heating device 90T according to the third embodiment of the present disclosure. The heating device 90T includes a plurality of engagements 348 that is mounted on the inner face of the downstream guide 342 and arranged with an identical gap between adjacent ones of the engagements 348 in a longitudinal direction of the holder 340. The rectangular holes 382 disposed in the upstream end 380u of the slide sheet 380 depicted in FIG. 4B engage the engagements 348, respectively. According to the second embodiment depicted in FIGS. 6A, 6B, and 6C, the notches 343 are disposed in the downstream guide 342. Conversely, according to the third embodiment depicted in FIG. 7, the downstream guide 342 is continuous in the longitudinal direction of the holder 340, improving stability of the fixing belt 310 guided by the downstream guide 342.

The downstream end of the elastic body 375 in the rotation direction D310 of the fixing belt 310 contacts the engagements 348. However, pressure is not exerted to the downstream end of the elastic body 375 directly at the fixing nip SN. Hence, the heating device 90T does not incorporate a notch that is disposed in the downstream end of the elastic body 375 and is retracted from the engagement 348. The downstream end of the elastic body 375 contacts the plurality of engagements 348, suppressing shifting of the elastic body 375 and the heater 350 downstream in the rotation direction D310 of the fixing belt 310, that might be caused by frictional sliding of the fixing belt 310 over the heater 350 and the slide sheet 380 covering the elastic body 375.

A description is provided of the construction of the heating device 90U according to the fourth embodiment of the present disclosure.

FIG. 8 illustrates the heating device 90U according to the fourth embodiment of the present disclosure. The heating device 90U includes a second holder 400 that holds the elastic body 375. For example, unlike the heating devices 90, 90S, and 90T according to the first to third embodiments, respectively, that incorporate the elastic body 375 placed directly inside the recess 345 of the holder 340, the elastic body 375 of the heating device 90U is mounted on the second holder 400 and secured to the second holder 400 with an adhesive or the like. The second holder 400 mounting the elastic body 375 is placed inside the recess 345.

The elastic body 375 mounted on the second holder 400 is placed inside the recess 345 of the holder 340. Hence, compared to a configuration in which the elastic body 375 is solely placed inside the recess 345, the elastic body 375 mounted on the second holder 400 is handled readily, improving installation and precision in positioning of the elastic body 375.

Engaged holes 410 are disposed in a bottom face of the second holder 400. Engagements 344U mounted on the bottom face of the recess 345 engage the engaged holes 410, respectively. The rectangular holes 382 disposed in the upstream end 380u of the slide sheet 380 engage the engagements 344U, respectively, that engage the second holder 400. Thereafter, the second holder 400 is placed on the bottom face of the recess 345. Accordingly, the engagements 344U mounted on the holder 340 engage the engaged holes 410 disposed in the second holder 400, respectively. The upstream end 380u of the slide sheet 380 is sandwiched between the second holder 400 and the bottom face of the recess 345.

As illustrated in FIG. 8, the heating device 90U according to the fourth embodiment includes the engagements 344U mounted on a bottom face of the holder 340. The engagements 344U are interposed between the holder 340 and the second holder 400. Unlike the heating device 90 depicted in FIG. 4A, the heating device 90U depicted in FIG. 8 does not incorporate the notches 375b disposed in the elastic body 375 and retracted from the engagements 344U, respectively. The positions of the second holder 400 and the elastic body 375 are restricted at two positions, that is, the engagements 344U mounted on the holder 340 and the downstream guide 342. Accordingly, the engagements 344U and the downstream guide 342 suppress shifting of the elastic body 375 and the heater 350 downstream in the rotation direction D310 of the fixing belt 310, that might be caused by frictional sliding of the fixing belt 310 over the heater 350 and the slide sheet 380 covering the elastic body 375, more precisely.

If the second temperature sensor 390 that detects the temperature of the elastic body 375 is installed into the heating device 90U, like the second temperature sensor 390 depicted in FIG. 4C, the holder 340 is provided with the first through hole 346 through which the second temperature sensor 390 is inserted. The second through hole 383 penetrates through the upstream end 380u of the slide sheet 380. The second through hole 383 is adjacent to the rectangular hole 382. The second holder 400 is provided with a third through hole 430. The tip portion 390a of the second temperature sensor 390 is inserted into the first through hole 346 penetrating through the holder 340, the second through hole 383 penetrating through the slide sheet 380, and the third through hole 430 penetrating through the second holder 400 and brought into contact with the bottom face of the elastic body 375.

A description is provided of the construction of the heating device 90V according to the fifth embodiment of the present disclosure.

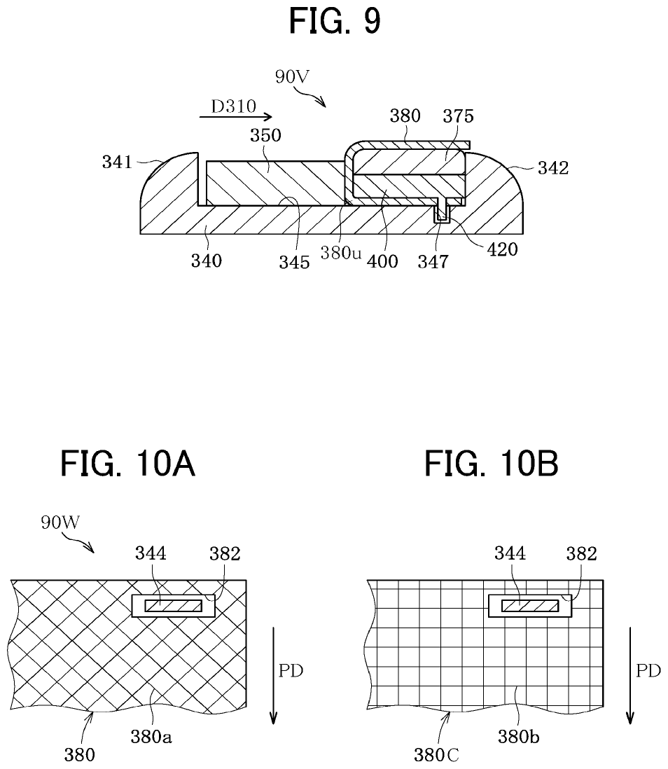

FIG. 9 illustrates the heating device 90V according to the fifth embodiment of the present disclosure. The heating device 90V according to the fifth embodiment includes engagements that project in a direction opposite a direction in which the engagements 344U of the heating device 90U according to the fourth embodiment depicted in FIG. 8 project. For example, an engaging projection 420 is mounted on the second holder 400. An engaging recess 347 is disposed in the holder 340. The engaging projection 420 mounted on the second holder 400 engages the engaging recess 347 through the second through hole 383 penetrating through the slide sheet 380. Other construction of the heating device 90V is equivalent to that of the heating device 90U depicted in FIG. 8.

In order to install the second temperature sensor 390 into the heating device 90V, like the second temperature sensor 390 depicted in FIG. 8, the holder 340 is provided with the first through hole 346 through which the second temperature sensor 390 is inserted. In addition to the rectangular hole 382, the slide sheet 380 is provided with the second through hole 383 separately, through which the second temperature sensor 390 is inserted. Alternatively, the engaging recess 347 disposed in the holder 340 may be a through hole penetrating through to the bottom face of the holder 340. The through hole may also be used as a through hole through which the second temperature sensor 390 is inserted.

A description is provided of the construction of the heating device 90W according to the sixth embodiment of the present disclosure.

FIG. 10A illustrates the heating device 90W according to the sixth embodiment of the present disclosure. The heating device 90W according to the sixth embodiment includes the slide sheet 380 having a fiber 380a oriented in a direction diagonal to a pull direction PD (e.g., the rotation direction D310 of the fixing belt 310) in which the fixing belt 310 pulls the slide sheet 380 while the fixing belt 310 slides over the slide sheet 380 frictionally. A diagonal angle is not limited to 45 degrees and is an arbitrary angle of 30 degrees, 60 degrees, or the like. Since the fiber 380a is oriented in the direction diagonal to the pull direction PD, a force exerted to an inner peripheral edge of the rectangular hole 382 by the engagement 344 is dispersed to warp and weft of the fiber 380a, enhancing a strength with which the rectangular hole 382 engages the engagement 344 and durability of the slide sheet 380.

Conversely, as illustrated in FIG. 10B, a comparative slide sheet 380C has a fiber 380b. Warp of the fiber 380b is oriented in a direction identical to the pull direction PD in which the fixing belt 310 pulls the comparative slide sheet 380C while the fixing belt 310 slides over the comparative slide sheet 380C frictionally. Weft of the fiber 380b is oriented in a direction perpendicular to the pull direction PD. Hence, if stress is concentrated on a corner of the rectangular hole 382, cracks may generate from the corner of the rectangular hole 382 easily.

The above describes the embodiments of the present disclosure. However, the technology of the present disclosure is not limited to the embodiments described above and is modified within the scope of the present disclosure. For example, according to the embodiments described above, a heating device (e.g., the heating devices 90, 90S, 90T, 90U, 90V, and 90W) is applied to a fixing device (e.g., the fixing device 300) for fixing a toner image on a sheet P, that is installed in an image forming apparatus (e.g., the image forming apparatus 100) for forming the toner image on the sheet P by electrophotography. However, the heating device according to the embodiments of the present disclosure is also applicable to devices other than the fixing device. For example, the heating devices 90, 90S, 90T, 90U, 90V, and 90W are also applicable to a heating device that corrects curling of a recording medium used in an inkjet printer.

A description is provided of advantages of a heating device (e.g., the heating devices 90, 90S, 90T, 90U, 90V, and 90W).

As illustrated in FIGS. 2 and 4A, the heating device includes an endless rotator (e.g., the fixing belt 310), a heater (e.g., the heater 350), an elastic body (e.g., the elastic body 375), a holder (e.g., the holder 340), a pressure rotator (e.g., the pressure roller 320), and a slide sheet (e.g., the slide sheet 380).

The endless rotator rotates in a rotation direction (e.g., the rotation direction D310). The heater contacts an inner circumferential surface of the endless rotator and extends in an axial direction (e.g., a longitudinal direction) of the endless rotator. The elastic body is disposed opposite the inner circumferential surface of the endless rotator and is disposed downstream from the heater in the rotation direction of the endless rotator. The holder holds the heater and the elastic body. The pressure rotator is disposed opposite the heater and the elastic body via the endless rotator to form a nip (e.g., the fixing nip SN) between the endless rotator and the pressure rotator, through which a recording medium (e.g., a sheet P) bearing an image is conveyed. The slide sheet is interposed between the endless rotator and the elastic body and covers a surface of the elastic body. For example, the slide sheet covers at least a surface of the elastic body, that is disposed opposite the endless rotator. The slide sheet includes an upstream end (e.g., the upstream end 380u) in the rotation direction of the endless rotator. The upstream end of the slide sheet is secured to the holder in a state in which the upstream end is inserted into a gap between the elastic body and the holder through a gap between the heater and the elastic body. For example, the upstream end is sandwiched between the heater and the elastic body and between the elastic body and the holder.

Accordingly, the upstream end of the slide sheet is secured to the holder precisely, preventing the slide sheet from being deformed into creases and preventing pressure exerted at the nip by a surface of the pressure rotator from destabilizing or fluctuating.

According to the embodiments described above, the fixing belt 310 serves as an endless rotator. Alternatively, a fixing film, a fixing sleeve, or the like may be used as an endless rotator. Further, the pressure roller 320 serves as a pressure rotator. Alternatively, a pressure belt or the like may be used as a pressure rotator.

The above-described embodiments are illustrative and do not limit the present disclosure. Thus, numerous additional modifications and variations are possible in light of the above teachings. For example, elements and features of different illustrative embodiments may be combined with each other and substituted for each other within the scope of the present disclosure.

Any one of the above-described operations may be performed in various other ways, for example, in an order different from the one described above.

What is claimed is:

1. A heating device comprising:
an endless rotator configured to rotate in a rotation direction;
a heater configured to contact an inner circumferential surface of the endless rotator and extend in an axial direction of the endless rotator;
an elastic body disposed opposite the inner circumferential surface of the endless rotator and disposed downstream from the heater in the rotation direction of the endless rotator;
a holder configured to hold the heater and the elastic body;
a pressure rotator disposed opposite the heater and the elastic body via the endless rotator to form a nip between the endless rotator and the pressure rotator; and
a slide sheet configured to cover a surface of the elastic body,
the slide sheet including an upstream end in the rotation direction of the endless rotator, the upstream end sandwiched between the heater and the elastic body and between the elastic body and the holder, the upstream end secured to the holder.

2. The heating device according to claim 1, further comprising an engagement configured to secure the upstream end of the slide sheet to the holder.

3. The heating device according to claim 2, wherein the engagement is mounted on the holder.

4. The heating device according to claim 2, further comprising a notch disposed in the elastic body, the notch configured to accommodate the engagement.

5. The heating device according to claim 4, further comprising a rectangular tongue disposed in the slide sheet and accommodated in the notch, the rectangular tongue configured to engage the engagement.

6. The heating device according to claim 2, further comprising another holder through which the elastic body is held by the holder,
wherein the engagement is interposed between the holder and said another holder.

7. The heating device according to claim 6, further comprising an engaged hole disposed in said another holder, the engaged hole configured to engage the engagement.

8. The heating device according to claim 6, further comprising:
an engaging recess disposed in the holder; and
an engaging projection mounted on said another holder, the engaging projection configured to engage the engaging recess.

9. The heating device according to claim 2, further comprising a downstream guide disposed on a downstream end of the holder in the rotation direction of the endless rotator, the downstream guide configured to guide the inner circumferential surface of the endless rotator.

10. The heating device according to claim 9, further comprising a notch disposed in the downstream guide, the notch configured to accommodate the engagement.

11. The heating device according to claim 9,
wherein the engagement is mounted on an inner face of the downstream guide.

12. The heating device according to claim 2, further comprising a rectangular hole disposed in the upstream end of the slide sheet, the rectangular hole configured to engage the engagement.

13. The heating device according to claim 1, further comprising:
a temperature sensor configured to detect a temperature of the elastic body, the temperature sensor including a tip portion;
a first through hole penetrating through the holder, the first through hole through which the temperature sensor is inserted; and
a second through hole penetrating through the upstream end of the slide sheet, the second through hole through which the tip portion of the temperature sensor is inserted.

14. The heating device according to claim 1,
wherein the slide sheet further includes a fiber oriented in a direction diagonal to the rotation direction of the endless rotator.

15. The heating device according to claim 1,
wherein the slide sheet further includes a downstream end in the rotation direction of the endless rotator, the downstream end not fixed to the holder.

16. The heating device according to claim 1,
wherein the elastic body is made of silicone rubber.

17. The heating device according to claim 1,
wherein the endless rotator includes a belt.

18. A fixing device comprising:
an endless rotator configured to rotate in a rotation direction;
a heater configured to contact an inner circumferential surface of the endless rotator and extend in an axial direction of the endless rotator;
an elastic body disposed opposite the inner circumferential surface of the endless rotator and disposed downstream from the heater in the rotation direction of the endless rotator;
a holder configured to hold the heater and the elastic body;
a pressure rotator disposed opposite the heater and the elastic body via the endless rotator to form a nip between the endless rotator and the pressure rotator, the nip through which a recording medium bearing a developer is conveyed; and
a slide sheet configured to cover a surface of the elastic body,
the slide sheet including an upstream end in the rotation direction of the endless rotator, the upstream end sandwiched between the heater and the elastic body and between the elastic body and the holder, the upstream end secured to the holder.

19. An image forming apparatus comprising:
an image forming device configured to form an image; and
a fixing device configured to fix the image on a recording medium,
the fixing device including:
an endless rotator configured to rotate in a rotation direction;
a heater configured to contact an inner circumferential surface of the endless rotator and extend in an axial direction of the endless rotator;
an elastic body disposed opposite the inner circumferential surface of the endless rotator and disposed downstream from the heater in the rotation direction of the endless rotator;
a holder configured to hold the heater and the elastic body;
a pressure rotator disposed opposite the heater and the elastic body via the endless rotator to form a nip between the endless rotator and the pressure rotator, the nip through which a recording medium bearing a developer is conveyed; and
a slide sheet configured to cover a surface of the elastic body,
the slide sheet including an upstream end in the rotation direction of the endless rotator, the upstream end sandwiched between the heater and the elastic body and between the elastic body and the holder, the upstream end secured to the holder.
